(19) United States
(12) Patent Application Publication
(10) Pub. No.: US 2020/0318222 A1
(43) Pub. Date: Oct. 8, 2020

(54) SMCO5-BASED COMPOUNDS DOPED WITH FE AND NI FOR HIGH-PERFORMANCE PERMANENT MAGNETS

(71) Applicant: Lawrence Livermore National Security, LLC, Livermore, CA (US)

(72) Inventors: Alexander Landa, Livermore, CA (US); Vincenzo Lordi, Livermore, CA (US); Per Soderlind, Oakland, CA (US); Patrice Erne A. Turchi, Menlo Park, CA (US)

(21) Appl. No.: 16/478,807

(22) PCT Filed: Jan. 17, 2018
(86) PCT No.: PCT/US2018/014040

§ 371 Date: Jul. 17, 2019

Related U.S. Application Data
(60) Provisional application No. 62/447,373, filed on Jan. 17, 2017.

(51) Int. Cl. C22C 30/00; H01F 1/057

(52) U.S. Cl. CPC C22C 30/00; C22C 2202/02; H01F 1/057

(57) ABSTRACT

In accordance with one aspect of the presently disclosed inventive concepts, a magnet includes a material having a chemical formula: SmFe₃(Ni₁₋ₓCoₓ)₂, where x is greater than 0 and x is less than 1.

The United States Government has rights in this invention pursuant to Contract No. DE-AC52-07NA27344 between the United States Department of Energy and Lawrence Livermore National Security, LLC for the operation of Lawrence Livermore National Laboratory.

### FIELD OF THE INVENTION

The present invention relates permanent magnets, and more particularly, this invention relates to SmCo₅-based magnets.

### BACKGROUND

Among the great challenges of materials science is discovering a material that satisfies conflicting requirements and also possesses specific properties for a particular application. There is a need for strong permanent magnets to withstand higher temperatures, for example Curie temperatures ranging from 800 K to 1200 K, which the widely used neodymium-based magnets (Nd₂Fe₁₄B, Neomax®) cannot tolerate. Pure Samarium-Cobalt (SmCo) magnets (both SmCo₅ and Sm₂Co₁₇) satisfy this requirement and are less subject to corrosion than the neodymium-based magnets and thus do not require a coating. Moreover, pure SmCo magnets have strong resistance to demagnetization.

Three basic material parameters determine the intrinsic properties of hard magnetic materials: (i) spontaneous (saturation) magnetization, (Mₛ), (ii) Curie temperature (T_{c}), and (iii) magnetocrystalline anisotropy energy (MAE). An optimal technological permanent magnet has a large spontaneous magnetization (Mₛ≥˜1 MA), high Curie temperature (T_{c}≥˜550 K), and large MAE constant (K₁≥˜4 MJ/m³).

Pure SmCo₅ permanent magnets exhibit enormously high uniaxial MAE constant of K₁˜17.2 MJ/m³, nearly four times higher than Sm₂Co₁₇ magnets (MAE with a K₁ of 4.2 MJ/m³) and have high Curie temperature, T_{c}˜1020 K. However, the Nd₂Fe₁₄B magnet currently dominates the world market for permanent magnets (˜62% of world market), since the Nd₂Fe₁₄B magnet has large spontaneous magnetization and possesses the highest energy performance measured by a record high energy product. The Maximum Energy Product (BH)ₘₐₓ of the Nd₂Fe₁₄B magnet at 512 kJ/m³ is more than twice as high as the (BH)ₘₐₓ of SmCo₅ magnets, at 231 kJ/m³. Although SmCo₅ magnets are more suitable for high temperature applications than Nd₂Fe₁₄B magnets, the relatively low energy performance of SmCo₅ magnets results in a low distribution of 3% of the world market.

It would be desirable to formulate a permanent magnet with a greater spontaneous magnetization, high MAE and thermostability comparable to SmCo₅ magnets while having a high Curie temperature.

### SUMMARY

In accordance with one aspect of the presently disclosed inventive concepts, a magnet includes a material having a chemical formula: SmFe₃(Ni₁₋ₓCoₓ)₂, where x is greater than 0 and x is less than 1.

In accordance with another aspect of the presently disclosed inventive concepts, a magnet includes a material having a chemical formula: SmFe₃(Ni₁₋ₓCoₓ)₂, where x is greater than 0 and x is less than 1, and where the material has a CuCa₅-type crystal structure

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 is a schematic drawing of a crystal structure (CaCu₅-type) of a SmCo₅ compound, according to inventive concepts described.

FIG. 2A is plot of formation energies relative to increasing number of TM 3d electrons per TM atom in various SmTM₅ compounds.

FIG. 2B (inset in FIG. 2A) is a plot of formation energies relative to increasing mole fraction of Ni in various SmFe₃(Co₁₋ₓNiₓ)₂ compounds.

FIG. 3 is plot comparing calculated and experimental photoemission spectra from total electronic density states of SmCo₅ compound using different theoretical methods for the calculations.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The term “dopant” as used in the instant descriptions shall be understood to encompass any element or compound that is included in a host medium material, so as to convey a particular functional characteristic or property on the resulting structure. In most cases, the dopant will be incorporated into a crystal structure of the host medium material, e.g., during ceramic processing.

In accordance with one general aspect of the presently disclosed inventive concepts, a magnet includes a material having a chemical formula: SmFe₃(Ni₁₋ₓCoₓ)₂, where x is greater than 0 and x is less than 1.

In accordance with another general aspect of the presently disclosed inventive concepts, a magnet includes a material having a chemical formula: SmFe₃(Ni₁₋ₓCoₓ)₂, where x is greater than 0 and x is less than 1, and where the material has a CuCa₅-type crystal structure

A list of acronyms used in the description is provided below.
Δ angstrom
at % atomic percent
(BH)ₘₐₓ Maximum Energy Product
Co Cobalt
DMFT Dynamical mean-field theory
EF Fermi level
Fe Iron
GPa gigapascal
HIA Hubbard I-Approximation
K Kelvin, T_{c} temperature
K₁ Magnetocrystalline anisotropy energy constant
kJ kilojoules
m meters
MA mega amperes
meV milli-electronvolts
MJ megajoules
MAE Magnetocrystalline anisotropy energy
Mₛ spontaneous magnetization
Nd Neodymium
Ni Nickel
Ca Calcium
Cu Copper
RE Rare earth metal
Sm Samarium
SRM Standard rare-earth model
SPTF Spin-polarized T-matrix fluctuation exchange
T_{c} Curie temperature
TM Transition-Metal
μ_{B} Bohr magneton

According to various inventive concepts described herein, a permanent magnet may be formed that has a high spontaneous magnetization, thermostability at high Curie temperatures and high magnetocrystalline anisotropy energy (MAE). Ideally, transition-metal dopants may boost the energy product of SmCo₅ magnets without compromising the high MAE and thermostability at high Curie temperatures of these magnets. For example, combining transition-metal (TM) with rare-earth-metal (RE) atoms in various intermetallic compounds may result in material in which RE and TM atoms induce a large magnetic anisotropy and provide a large magnetization and high Curie temperature.

Iron (Fe) is more readily available than cobalt (Co) such that Fe is ˜2000 times more abundant in the Earth's crust than Co. Thus, at least from a cost stand point, it would be beneficial to substitute Co atoms in SmCo₅ with Fe atoms since the relative abundance of available Fe could result in a less expensive component. In addition, Fe may be desirable as an added component to a magnet material since its ferromagnetic metal properties have a large magnetization at room temperature (1.76 MA/m).

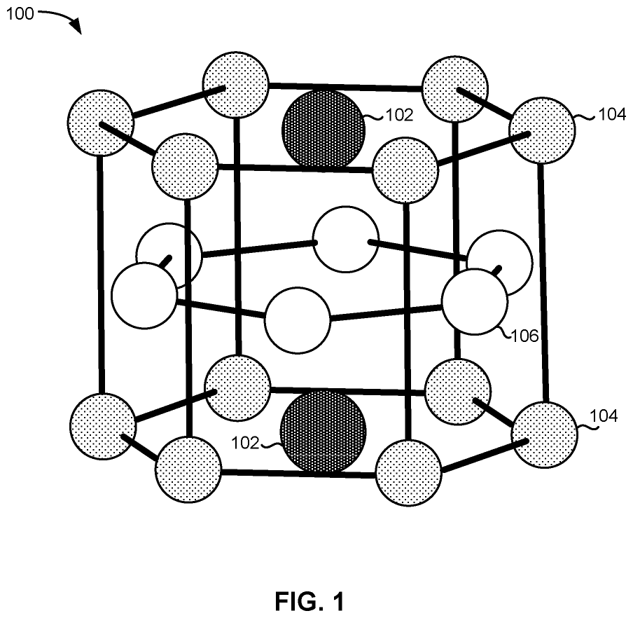

FIG. 1 depicts a structure 100 of a material of a magnet, in accordance with inventive concepts described herein. As an option, the present structure 100 may be implemented in conjunction with features from any other inventive concepts listed herein, such as those described with reference to the other FIGS. Of course, however, such structure 100 and others presented herein may be used in various applications and/or in permutations which may or may not be specifically described in the illustrative concepts listed herein. Further, the structure 100 presented herein may be used in any desired environment.

As shown in FIG. 1, the crystal structure of a CaCu₅ (D_{2d})-type structure 100 with three distinct atoms displayed, may represent a SmCo₅ compound crystal structure. A samarium atom (Sm₁) may be in the Wyckoff position 1a 102 centered in a plane with two Co₁ atoms in the position 2c 104 surrounding the Sm₁ in the position 1a 102 and a second layer with three more Co₂ atoms in the position 3g 106 for a total of six atoms in the unit cell. Bonding and energy between the atoms of a crystal structure may be defined by the interactions between 3d-orbital electrons of the transition metals in the position 2c 104 or position 3g 106 and the 5d-orbital electrons from samarium (Sm₁) in the center position 1a 102 as shown in FIG. 1.

In the SmFe₅ compound that only include Fe atoms without any Co atoms, the instability of the crystal structure may be related to a decrease in the number of 3d electrons in the electronic structure. Indeed, crystal stabilities of the magnetic 3d transition metals may be governed by the number of 3d electrons.

Thus, substituting all cobalt atoms with a transition metal with higher magnetic moment, such as iron, in order to optimize the maximum energy product (i.e., SmCo₅→SmFe₅) may result in a thermodynamically unstable crystal structure of an ordinary hexagonal phase. Moreover, SmFe₅ does not appear in the equilibrium Sm—Fe phase diagram, although the alloy compound Sm(Co₁₋ₓFeₓ)₅ with CaCu₅-type structure has been synthesized by the melt-spinning method for x=0.0-0.3.

In contemplated approaches, Sm(Co₁₋ₓFeₓ)₅ materials have been synthesized. Furthermore, the Curie temperatures (T_{c}) for Sm(Co₁₋ₓFeₓ)₅ alloys were found to increase from about 1020 K to about 1080 K when increasing x from 0.0 to 0.2. In contrast, Sm₂(Co₁₋ₓFeₓ)₁₇ alloys exhibit a monotonic decrease in Curie temperature (T_{c}) with increasing Fe content.

Accordingly, the inventive concepts presented herein, in several embodiments, involve ab initio calculations to add nickel (Ni) and iron (Fe) to a SmCo₅ magnet in order to stabilize Sm(Co—Fe—Ni)₅ alloys containing a sufficient amount of Fe to boost the energy product of the Sm(Co—Fe—Ni)₅ magnet.

In accordance with inventive concepts described herein, a magnet includes a material having a chemical formula: SmFe₃(Ni₁₋ₓCoₓ)₂, wherein x may be greater than 0 and x may be less than 1. In some approaches, the material may have a chemical formula: SmFe₃(Ni₁₋ₓCoₓ)₂, where x may be greater than 1−x such that the compound has a greater amount of Co compared to Ni. Accordingly, x may be a value between 0.5 and 1, such as 0.51, 0.52 . . . 0.98, 0.99. In other approaches, the material may have a chemical formula: SmFe₃(Ni₁₋ₓCoₓ)₂, where x may be less than 1−x, such that the compound has a greater amount of Ni compared to Co. Accordingly, x may be a value between 0 and 0.5, such as 0.01, 0.02 . . . 0.48, 0.49. Preferably, whether x is greater than or less than 1-x, the values are within a 10% difference of one another, e.g., x is a value in a range of 0.45-0.55. In preferred approaches, the material may have a chemical formula: SmFe₃(Ni₁₋ₓCoₓ)₂, where x is about equal to 1-x.

Preferably, the magnet as described in the inventive concepts herein includes a reduced amount of cobalt (up to 80% less Co) than the amount of Co in SmCo₅. Moreover, the magnet as described may be a permanent magnet.

The magnet compound of SmFe₃(Ni₁₋ₓCoₓ)₂ material as described herein may have a CaCu₅-type crystal structure. Referring again to FIG. 1, the SmFe₃(Ni₁₋ₓCoₓ)₂ may form a hexagonal CaCu₅-type structure 100: Sm₁ in position 1a 102, Co atoms and Ni atoms sharing position 2c 104 sites, and Fe atoms in position 3g 106 non-equivalent atomic sites with 6 atoms per formula unit.

In the inventive concepts described herein, a thermodynamically stable permanent magnet, for example having the chemical formula SmFe₃(Ni_{0.5}Co_{0.5})₂, may include no more than three Fe atoms per unit of the compound. Ideally, the Fe atoms would be distributed in the transition metal position 3g 106 nonequivalent atomic sites (as shown in FIG. 1) of the crystal structure 100.

According to inventive concepts described, the addition of Ni to Sm(Co₁₋ₓFeₓ)₅ magnets may stabilize the magnet. Transition metals have increasing 3d electron count in the following order: Fe<Co<Ni. Thus, replacing Co atoms with Fe atoms decreases the amount of 3d electrons in the compound, whereas replacing Co atoms with Ni atoms increases the amount of 3d electrons in the compound.

According to inventive concepts described herein, the resulting SmFe₃(Ni₁₋ₓCoₓ)₂ magnet may have a large energy product. State of the art electronic structure calculations confirmed that addition of Ni to SmCo₅ magnets stabilized Sm(Co₁₋ₓFeₓ)₅ and maintained a reasonably high MAE comparable with the MAE of SmCo₅ magnets (see below in Experiments).

According to inventive concepts described herein, a magnet with SmFe₃(Ni₁₋ₓCoₓ)₂ material includes Ni atoms and the Co atoms may be distributed in transition metal 2c nonequivalent atomic sites. Moreover, high axial MAE may be obtained with energetically stable SmFe₃(Ni₁₋ₓCoₓ)₂ alloys using abundant and cost-effective Fe and Ni in place of expensive Co, and thereby achieving higher magnetic energy product compared to the SmCo₅ prototype compound. Some approaches may include a SmFe₃(Ni₁₋ₓCoₓ)₂ compound with partial ordering on the 2c-type sites.

A magnet of SmFe₃(Ni₁₋ₓCoₓ)₂ includes a spin orientation of the Sm atom that may be antiparallel to a spin orientation of the Fe, Ni, and Co atoms. The spin properties of the electrons in an atom generate a magnetic moment of the atom, as measured in terms of Bohr magneton (μ_{B}). Theoretical measurements of the SmFe₃(Ni₁₋ₓCoₓ)₂ magnet show magnetic moments of Sm to be opposite atoms of each of the transition metals (e.g. Co, as shown below in Table 1).

Permanent magnets preferably include material with a high magnetocrystalline anisotropy energy (MAE). The MAE is the very small energy difference between phases with spin moments oriented in the easy and hard directions. The MAE may be defined by appropriate representation of the electronic and magnetic structures. In terms of uniaxial anisotropy, the MAE constant K₁>0, where the MAE constant K₁ is expressed in MJ/m³ units. The opposite case, K₁<0, corresponds to the planar anisotropy. The magnitude of the MAE constant, K₁, reflects the magnitude of MAE such that a larger positive value of K₁ constant corresponds to a larger uniaxial MAE.

A magnet of SmFe₃(Ni₁₋ₓCoₓ)₂ may have a MAE that is about twice a MAE of Nd₂Fe₁₄B. In some approaches, a magnet of SmFe₃(Ni₁₋ₓCoₓ)₂ has a magnetocrystalline anisotropy energy constant (K₁) that may be greater than about 9 MJ/m³.

In some approaches, the SmFe₃(Ni₁₋ₓCoₓ)₂ material may have a high MAE that may be comparable to the MAE of praseodymium (PrCo₅) and yttrium (YCo₅) magnets of 8.1 MJ/m³ and 6.5 MJ/m³, respectively. The theoretical values of the SmFe₃(Ni₁₋ₓCoₓ)₂ compounds described herein were derived using novel computational material science approaches (see below in Experiments).

It is desirable for a magnet material to have a high Curie temperature (T_{c}) in order to continue to function as a magnet under conditions with elevated temperatures. According to inventive concepts described herein, the material of the magnet SmFe₃(N₁₋ₓCoₓ)₂ has a Curie temperature (T_{c}) that may be about equal to a Curie Temperature of SmCo₅. In some approaches, the material of the magnet SmFe₃(Ni₁₋ₓCoₓ)₂ may have a T_{c} greater than about 1100 K.

Moreover, the SmFe₃(Ni₁₋ₓCoₓ)₂ compound may have a high magnetic energy product, comparable to neodymium-based magnets. The material of the magnet SmFe₃(Ni₁₋ₓCoₓ)₂ may have a maximum energy product of the material greater than about 361 kJ/m³.

There are potentially many ways to produce the magnets described here, as would be readily apparent to one skilled in the art after reading the present disclosure. Any such method may be used to present the novel materials described herein.

An illustrative method to form a permanent magnet, which is presented by way of example only, may include starting with a SmNi₅ compound that is in a CaCu₅-type structure. A maximum amount of Fe metal (e.g., ˜50 at %) may be dissolved with the SmNi₅ compound to form a stable SmFe₃Ni₂ compound in the same structure modification where iron atoms predominantly occupy 3g sites of the crystal structure. In an ideal crystal structure, Fe atoms occupy all 3g positions.

The formation method may subsequently include gradual alloying of the SmFe₃Ni₂ compound with Co, while keeping the amount of Sm and Fe constant. In a preferred embodiment, half of the Ni atoms may be replaced with Co atoms.

Experiments

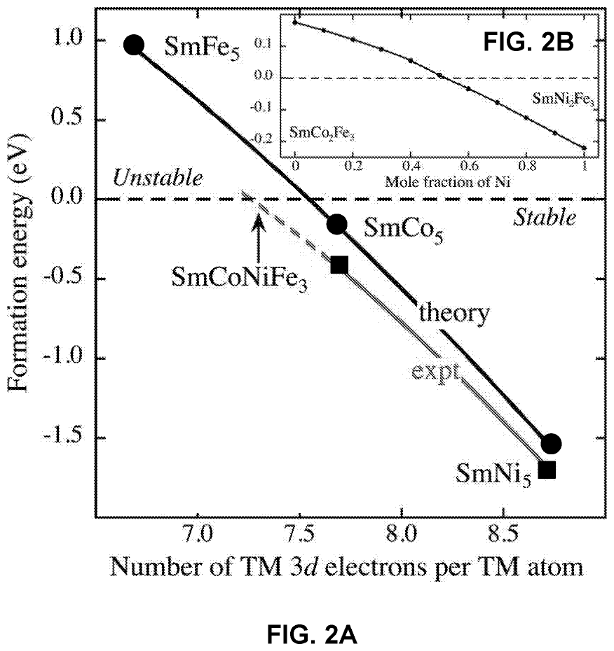

FIGS. 2A and 2B depict a correlation between the number of transition-metal (TM) 3d electrons and the stability of the hexagonal crystal structure SmTM₅ (D_{2d}) compound. FIG. 2A depicts results from calculations of formation energies of theoretical SmTM₅ compounds, where TM=Fe, Co, Ni, as a function of the valence 3d-electron band occupation (● curve).

The heat of formation (y-axis, FIG. 2A) may be calculated with respect to the ground-state structures of the pure elements, i.e., α-structure of Sm, hexagonal close packed (hcp) Co, body centered cubic (bcc) Fe, and face centered cubic (fcc) Ni. As confirmed in FIG. 2A, increasing the 3d electron count, by adding in Co atoms and then Ni atoms (theoretical ● curve), the formation energy decreased and the crystal structure stabilized. Thus, the stability of a Sm—Fe alloy may be recovered by doping with 3d electrons from Ni. Experimental results (▪ curve) demonstrated by extrapolation (dashed curve) of the experimental heats of formation suggested that an alloy with at least 7.2 3d electrons per TM atom may be stable. In the inventive embodiment described herein, a SmCoNiFe₃ compound having about 7.3 3d electrons may results in a stabilized magnet material.

Moreover, a related alloy SmNi₂Fe₃, as shown in FIG. 2B in the plot inset in FIG. 2A, has about 7.5 3d electrons and exhibits similar curve as shown in FIG. 2A as Ni atoms replace the Co atoms of a SmCo₂Fe₃ compound.

A combination of Co and Ni were substituted at sites at the position 2c for the Sm(CoₓNi₁₋ₓ)₂Fe₃ alloy (FIG. 2B). As shown in the curve, about a 50% (x≈0.5) mole fraction of Ni atoms (x-axis) preserved the stable hexagonal phase of the crystal structure. Thus, these results suggested that equal mole fractions of Co atoms and Ni atoms provided a stable crystal structure of Sm(Co_{0.5}Ni_{0.5})₂Fe₃.

TABLE 1
Calculated and measures magnetic moments (μ_{B}) for SmCo₅ magnet.

| | | | | | Total |
|---|---|---|---|---|---|
| Method of | Sm₁ (1a) | Co₁ (2c) | Co₂ (3g) | Interstitial | Magnetic |
| measurement | Spin, Orbital, Total | Spin, Orbital, Total | Spin, Orbital, Total | Spin | Moment |
| DMFT-HIA | −2.82, 2.76, −0.06 | 1.54, 0.24, 1.78 | 1.52, 0.20, 1.72 | −0.46 | 8.20 |
| DFT-SRM | −0.30 | 1.61, 0.22, 1.83 | 1.60, 0.18, 1.78 | −0.43 | 8.27 |
| Polarized-neutron | 0.38 (4.20K) | —, —, 1.86 | —, —, 1.75 | — | 9.35 |
| diffraction | 0.00 (850K) | —, —, 1.86 | —, —, 1.86 | — | 8.97 |

One approach to predict magnetic properties of theoretical SmCo₅ compounds included statistical analysis of compositional disorder of TM-types sites. Another approach includes state-of-the-art analysis of electronic structure to treat RE (Sm) metal with almost localized 4f-electrons. The maximum energy product and the magnetic moment are measures of magnetic strength. A material of SmCoNiFe₃ compound demonstrated a magnetic moment of ˜10μ_{B}. Without wishing to be bound by any theory, it was believed that the Fe atoms of the SmCoNiFe₃ contributed a magnetic moment of about ˜2.7μ_{B} per Fe atom. Looking to Table 1 (above) that lists calculated and measured magnetic moments for SmCo₅, a magnetic moment of a SmCoNiFe₃ compound may be substantially greater than for the magnetic moment of a magnet of conventional SmCo₅ having a total moment of about 8μ_{B}

Calculations described herein for MAE of the SmCo₅ compounds used an accurate parameter-free first-principles theory based on the standard rare-earth model. This model is shown to be consistent with dynamical mean-field theory (DMFT) that captured electronic spectra and magnetic moments of the materials. In brief, correlated and localized samarium (Sm) 4f electrons were treated within the Hubbard I approximation (HIA) and the cobalt 3d electrons were treated with the spin-polarized T—matrix fluctuation exchange (SPTF) solver. DMFT analysis of SmCo₅ included a description of the electronic structure of SmCo₅. However, the standard rare-earth model (SRM) was a simpler method than the DMFT method, and captured the main physics of the DMFT analysis. Briefly, the SRM includes the assumption, without wishing to be held to any theory, that the 4f shell is part of the samarium (Sm) atomic core and does not specifically hybridize with any valence states. Experiments appeared to confirm this theory, in that the Sm—Co alloy system showed no significant overlap between samarium 4f and cobalt 3d states. Moreover, the respective peak intensity of Sm 4f and Co 3d states were far apart (6 eV).

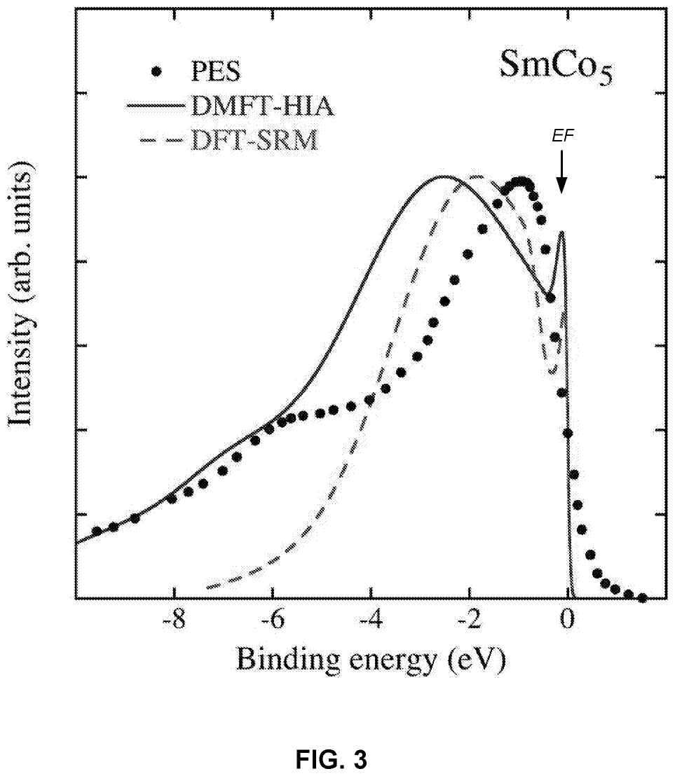

Looking to FIG. 3, an experimental photoemission spectrum (PES) (●) is shown with the theoretical DMFT-HIA (solid line) and density-functional-theory SRM (DFT-SRM) (dashed line) results for SmCo₅. Both theoretical models produced spectra close to zero binding energy (Fermi level, EF, at arrow) with quantitative shape similar to the experimental PES curve (●), however each theoretical curve had a peak that was slightly shifted relative to the experimental PES. The DMFT-HIA (solid line) captured the deeper lying 4f states about 6 eV below EF. The states close to EF represent important states for orbital magnetism and magnetic anisotropy.

Looking to Table 1 (see above) theoretical magnetic moments of SmCo₅ have been compared with polarized-neutron diffraction experiments. Comparing the different methods of measurement, the magnetic moments were comparable. Moreover, the theoretical results of magnetic moments using the different methods of measurement combined with the results of the electronic spectra of FIG. 3, demonstrated reasonable methods for magnetic anisotropy in SmCo₅-related magnets.

With continued reference to Table 1, in the ground-state configuration, the Sm₁ (negative sign) and Co₁ and Co₂ (positive sign) spin moments align anti-parallel in agreement as would be expected by one skilled in the art. In contrast, when the spins couple parallel, the energy of the system may be considerably higher (about 0.1 eV, not shown) at an excited energy state that is metastable and not relevant for SmCo₅.

Moreover, the orbital magnetic moment on the Co₁ atom (0.24 and 0.22) was greater than on the Co₂ atom (0.20 and 0.18) for both methods. Without wishing to be bound by any theory, these measurements may confirm experimental results where polarized nuclear magnetic-resonance measurements have shown that the two Co atoms (Co₁ and Co₂) have opposing effects on the magnetic anisotropy. Thus, the cobalt orbital moments may be described as Co₁>Co₂ when predicting the axial MAE of the SmCo₅ compounds.

Using the above theoretical values of total energies of SmCo₅, a crystal structure was optimized, and a unit-cell volume was obtained at 86.0 Å³ with a bulk modulus of 141.9 GPa, which compared similarly to an experimental crystal structure of SmCo₅ compound formed at room temperature with a unit-cell volume of 85.74 Å³ and bulk modulus of 138.7 GPa. The theoretical hexagonal axial c/a ratio was found to be somewhat small (0.77) relative to the hexagonal axial c/a ratio of 0.798 in the experimental crystal structure.

In Table 2 the theoretical magnetocrystalline anisotropy energies (MAE) for α-Co, SmCo₅, and SmNi₅ were compared with conventional experimental reports, for example, the MAE for SmCo₅ was 17.20 MJ/m³. The theoretical values of α-Co, SmCo₅, and SmNi₅ corresponded similarly to the experimental values, and thus, the theoretical value of SmNiCoFe₃ compound, 9.216 MJ/m³, derived by similar methods may be credible.

Furthermore, the increased presence of Ni appeared to affect the MAE sensitivity of the compound. As shown in the Table 2, replacing 5% Co in the SmCoNiFe₃ compound with 5% Ni, resulting in SmCo_{0.45}Ni_{0.55}Fe₃ compound, lowered the theoretical MAE by 12% from 9.216 MJ/m³ to 8.094 MJ/m³.

Table 3 summarizes the theoretical magnetic values of the SmCoNiFe₃ compound with the experimental magnetic values of conventional Nd₂Fe₁₄B and SmCo₅ compounds. Notably the MAE constant of the SmCoNiFe₃ compound (9.2 MJ/m³) is smaller than SmCo₅ (17.2 MJ/m³).

TABLE 2
Magnetic anisotropy energy constants measured in MJ/m³.

| Magnet | Theory | Experiment |
|---|---|---|
| α-Co | 0.329 | 0.24 |
| SmCo₅ | 19.630 | 17.20 |
| SmCo₂Fe₃ | 14.110 | — |
| SmCoNiFe₃ | 9.216 | — |
| Sm(Co_{0.45}Ni_{0.55})₂Fe₃ | 8.094 | — |
| SmNi₅ | 3.309 | 4.39 |

Theoretical values of Curie temperature, T_{c}, are calculated with exchange-coupling parameters mapped onto a Heisenberg model and mean field method (as shown in Table 3). When comparing theoretical value of the T_{c} for SmCoNiFe₃ relative to the T_{c} for SmCo₅, there was a modest decrease (5%) in T_{c} for SmCoNiFe₃(1103 K for SmCoNiFe₃ and 1158 K for SmCo₅). Calculated Curie temperature for SmCo₅ (T_{c}=1158 K) is comparable to the experimental value (T_{c}=1020 K), which was nearly twice as high as the T_{c} of the conventional Nd₂Fe₁₄B magnet (T_{c}=588 K).

The maximum energy product, [BH]ₘₐₓ, for the SmCoNiFe₃ compound (361 kJ/m³) is predicted to be significantly higher than the maximum energy product of SmCo₅ compound (231 kJ/m³). Thus, the maximum energy product increases from 45.3% (SmCo₅) to 70.5% (SmCoNiFe₃) of the magnitude (taken as 100%) of the highest industrially achievable maximum energy product of the Nd₂Fe₁₄B magnet (512 kJ/m³).

TABLE 3
Magnetic values of Permanent Magnet Compounds.

| Material | Mₛ (MA/m) | T_{c} (K) | K₁ (MJ/m³) | [BH]ₘₐₓ (kJ/m³) |
|---|---|---|---|---|
| SmCo₅ | 0.86 | 1020 | 17.2 | 231 |
| Nd₂Fe₁₄B⁺ | 1.28 | 588 | 4.9 | 512 |
| SmCoNiFe₃* | 1.08 | 1103 | 9.2 | 361 |

*Theoretical values derived from method described herein.
⁺Experiment

In Use

In use, the alloy formulations described herein may be useful as permanent magnets with high MAE and energy product, and useful for high-temperature applications. The SmCoNiFe₃ alloy formulations described may be used for cost-effective clean energy products.

The inventive concepts disclosed herein have been presented by way of example to illustrate the myriad features thereof in a plurality of illustrative scenarios, embodiments, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A magnet, comprising:
a material having a chemical formula: SmFe₃(Ni₁₋ₓCoₓ)₂, wherein x is greater than 0 and x is less than 1.

2. A magnet as recited in claim 1, wherein x is greater than 1−x.

3. A magnet as recited in claim 1, wherein x is less than 1−x.

4. A magnet as recited in claim 1, wherein x is about equal to 1−x.

5. A magnet as recited in claim 1, the material has a CuCa₅-type crystal structure.

6. A magnet as recited in claim 5, wherein the Fe atoms are distributed in a plurality of transition metal 3g nonequivalent atomic sites.

7. A magnet as recited in claim 5, wherein the Ni atoms and the Co atoms are distributed in a plurality of transition metal 2c nonequivalent atomic sites.

8. A magnet as recited in claim 1, wherein the magnet is a permanent magnet.

9. A magnet as recited in claim 1, wherein a spin orientation of the Sm atom is antiparallel to a spin orientation of the Fe, Ni, and Co atoms.

10. A magnet as recited in claim 1, wherein a magnetocrystalline anisotropy energy of the material is about twice a magnetocrystalline anisotropy energy of Nd₂Fe₁₄B magnet.

11. A magnet as recited in claim 1, wherein a magnetocrystalline anisotropy energy of the material is greater than about 9 MJ/m³.

12. A magnet as recited in claim 1, wherein a Curie Temperature of the material is about equal to a Curie Temperature of SmCo₅.

13. A magnet as recited in claim 1, wherein a Curie Temperature of the material is greater than about 1100 K.

14. A magnet as recited in claim 1, wherein a maximum energy product of the material is greater than about 361 kJ/m³.

15. A magnet as recited in claim 1, wherein the magnet comprises a reduced amount of Co than an amount of Co in SmCo₅.

16. A magnet as recited in claim 15, wherein the reduced amount of Co is up to 80% less Co than the amount of Co in SmCo₅.

17. A magnet, comprising:
a material having a chemical formula: SmFe₃(Ni₁₋ₓCoₓ)₂, wherein x is greater than 0 and x is less than 1, wherein the material has a CuCa₅-type crystal structure.

18. A magnet as recited in claim 17, wherein x is greater than 1−x.

19. A magnet as recited in claim 17, wherein x is about equal to 1−x.

20. A magnet as recited in claim 17, wherein the Fe atoms are distributed in a plurality of transition metal 3g nonequivalent atomic sites.

21. A magnet as recited in claim 17, wherein the Ni atoms and the Co atoms are distributed in a plurality of transition metal 2c nonequivalent atomic sites.
